(19) United States
(12) Patent Application Publication
(10) Pub. No.: US 2016/0151867 A1
(43) Pub. Date: Jun. 2, 2016

(54) Puller

(71) Applicant: Plus Craft Industrial Co., Ltd., Taichung City (TW)

(72) Inventor: Timmy Chen, Taichung City (TW)

(21) Appl. No.: 14/556,311

(22) Filed: Dec. 1, 2014

(51) Int. Cl. B23P 19/04

(52) U.S. Cl. CPC B23P 19/04

(57) ABSTRACT

A puller includes a main body, a plurality of connecting levers, a plurality of jaws and a limit sleeve unit. The main body has a plurality of connecting seats and a shaft hole. Each of the connecting levers is pivotally connected with each of the connecting seats of the main body. Each of the jaws is pivotally connected with each of the connecting levers. Each of the jaws 4 has an outer hooked portion and an inner hooked portion. The limit sleeve unit includes a sleeve mounted in the shaft hole of the main body and provided with a screw bore and an outer threaded portion, a threaded rod screwed through the screw bore of the sleeve, and a nut mounted on the sleeve and having an inner threaded portion screwed onto the outer threaded portion of the sleeve.

### BACKGROUND OF THE INVENTION

1. Field of the Invention

The present invention relates to a puller and, more particularly, to a puller that is used to remove a mechanical accessory, such as a bearing, a steering wheel, a gear and the like.

2. Description of the Related Art

A conventional puller in accordance with the prior art shown in FIGS. 1-6 comprises a main body 1, a plurality of connecting levers 1, a plurality of jaws 2, and a threaded rod 16. The main body 1 has a periphery provided with a plurality of connecting seats 11. The main body 1 is provided with a screw hole 15. Each of the connecting levers 13 has a first end pivotally connected with each of the connecting seats 11 of the main body 1 by a first bolt 12. Each of the jaws 2 is pivotally connected with a second end of each of the connecting levers 13 by a second bolt 14. Each of the jaws 2 has a first end provide with an outer hooked portion 21 and a second end provide with an inner hooked portion 22. The threaded rod 16 is screwed through the screw hole 15 of the main body 1. The threaded rod 16 has a first end provided with a driving portion 162 and a second end provided with an abutting portion 161. In operation, referring to FIGS. 1-3, when the puller is mounted on a mechanical accessory, such as a bearing, a steering wheel, a gear and the like, the outer hooked portion 21 of each of the jaws 2 is hooked onto the outer periphery of the mechanical accessory. Then, the threaded rod 16 is rotated relative to the main body 1 by driving the driving portion 162 of the threaded rod 16 so that the abutting portion 161 of the threaded rod 16 is moved downward to abut a mandrel of the mechanical accessory. Then, the threaded rod 16 is further rotated relative to the sleeve 51 so that the outer hooked portion 21 of each of the jaws 2 is moved upward to push the mechanical accessory upward relative to the mandrel so as to remove the mechanical accessory from the mandrel. On the contrary, referring to FIGS. 4-6 with reference to FIGS. 1-3, when the threaded rod 16 is rotated reversely, the threaded rod 16 is unscrewed from the screw hole 15 of the main body 1 and is moved upward relative to the main body 1 so that the threaded rod 16 is removed from the main body 1 as shown in FIG. 4. Then, the main body 1 is turned upside down so that the inner hooked portion 22 of each of the jaws 2 is disposed under the outer hooked portion 21 as shown in FIG. 5. Then, the threaded rod 16 is screwed through the screw hole 15 of the main body 1. Then, each of the connecting levers 13 is pivoted about the first bolt 12 and is moved downward, while each of the jaws 2 is pivoted about the second bolt 14 and is moved downward, so that the inner hooked portions 22 of the jaws 2 approach each other as shown in FIG. 6. In operation, the inner hooked portion 22 of each of the jaws 2 is hooked onto the inner periphery of the mechanical accessory. Then, the threaded rod 16 is rotated relative to the main body 1 by driving the driving portion 162 of the threaded rod 16 so that the abutting portion 161 of the threaded rod 16 is moved downward to abut the mandrel of the mechanical accessory. Then, the threaded rod 16 is further rotated so that the inner hooked portion 22 of each of the jaws 2 is moved upward to push the mechanical accessory upward relative to the mandrel so as to remove the mechanical accessory from the mandrel. However, when the user wishes to change the operation modes between the outer hooked portion 21 of each of the jaws 2 and the inner hooked portion 22 of each of the jaws 2, it is necessary to rotate and unscrew the threaded rod 16 from the screw hole 15 of the main body 1, then to turn the main body 1 upside down, and then to rotate and screw the threaded rod 16 into the screw hole 15 of the main body 1, so that the interchanging process between the first operation mode of the outer hooked portion 21 of each of the jaws 2 and the second operation mode of the inner hooked portion 22 of each of the jaws 2 is not performed easily and quickly, thereby wasting the user's energy and time.

### BRIEF SUMMARY OF THE INVENTION

In accordance with the present invention, there is provided a puller comprising a main body, a plurality of connecting levers, a plurality of jaws and a limit sleeve unit. The main body has a periphery provided with a plurality of connecting seats. The main body is provided with a shaft hole which extends through the main body. Each of the connecting levers has a first end pivotally connected with each of the connecting seats of the main body by a first bolt. Each of the jaws is pivotally connected with a second end of each of the connecting levers by a second bolt. Each of the jaws has a first end provide with an outer hooked portion and a second end provide with an inner hooked portion. The limit sleeve unit includes a sleeve mounted in the shaft hole of the main body and provided with a screw bore and an outer threaded portion, a threaded rod screwed through the screw bore of the sleeve, and a nut mounted on the sleeve and having an inner threaded portion screwed onto the outer threaded portion of the sleeve. The screw bore of the sleeve is located at a central position of the sleeve and extended through the sleeve. The outer threaded portion of the sleeve is formed on a first end of the sleeve. The threaded rod has a first end provided with a driving portion and a second end provided with an abutting portion.

The sleeve has an outer diameter with a shape corresponding to that of an inner diameter of the shaft hole of the main body. Preferably, the inner diameter of the shaft hole of the main body has a polygonal shape, and the outer diameter of the sleeve has a polygonal shape. Preferably, the sleeve has a second end provided with a stop portion.

According to the primary advantage of the present invention, the nut is screwed onto and unscrewed from the sleeve so that the sleeve is inserted into and detached from the shaft hole of the main body to change the outer hooked portion and the inner hooked portion of each of the jaws so that the user needs not to rotate the threaded rod, thereby saving the user's time and energy.

According to another advantage of the present invention, the nut is screwed onto the sleeve to assemble the puller and is unscrewed from the sleeve to disassemble the puller so that the puller is assembled and disassembled easily and quickly.

According to a further advantage of the present invention, the user only needs to screw the nut onto the sleeve and to unscrew the nut from the sleeve to change operation modes between the outer hooked portion and the inner hooked portion of each of the jaws so that the operation modes of the outer hooked portion and the inner hooked portion of each of the jaws are changed easily and conveniently, thereby facilitating the user operating the jaws of the puller.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a conventional puller in accordance with the prior art.

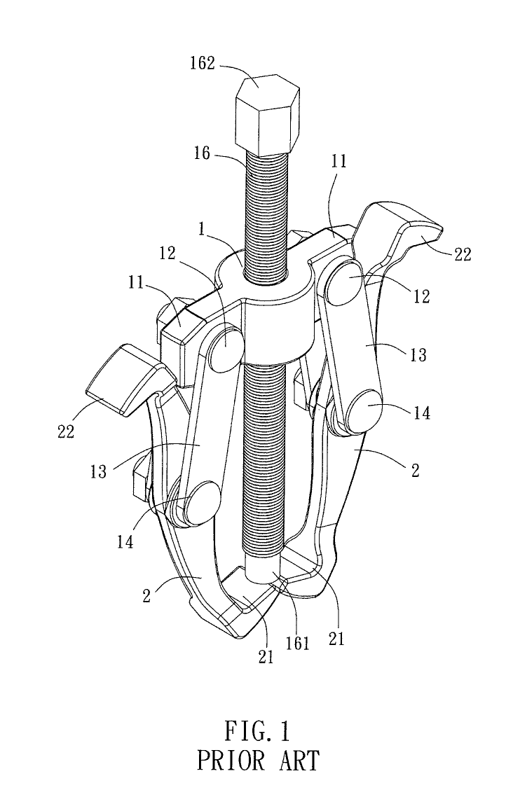

FIG. 2 is a partially exploded perspective view of the conventional puller as shown in FIG. 1.

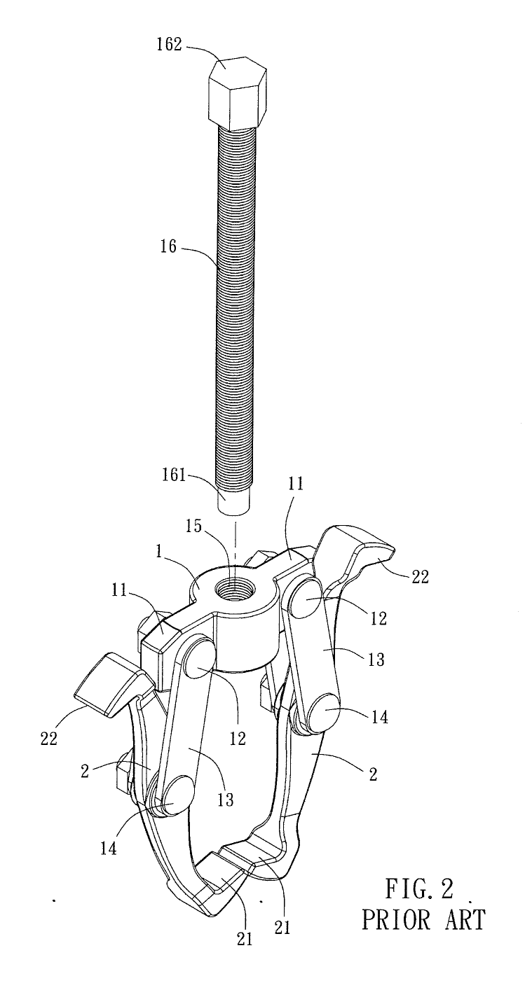

FIG. 3 is a partially cross-sectional view of the conventional puller as shown in FIG. 1.

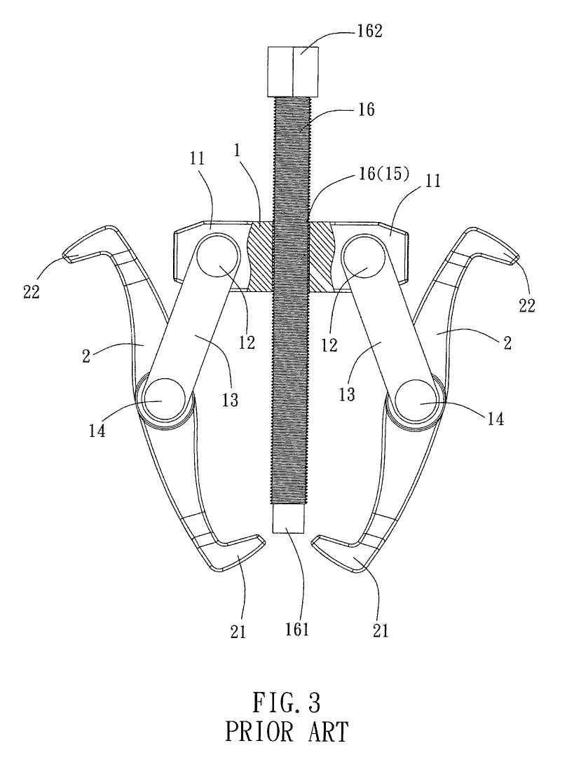

FIG. 4 is a front view of the conventional puller as shown in FIG. 2.

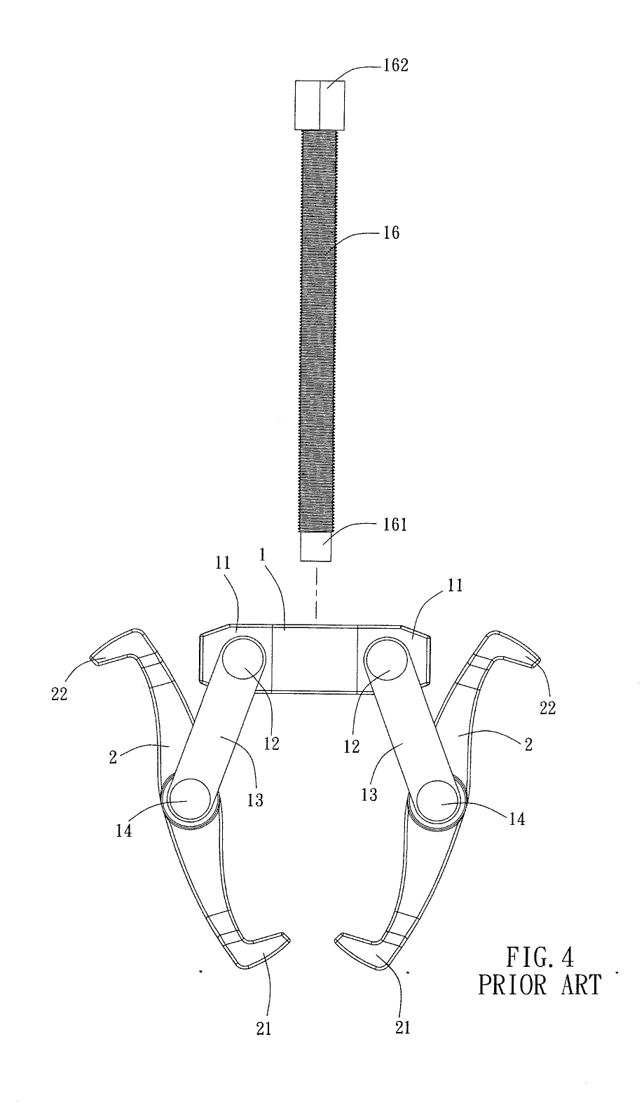

FIG. 5 is a schematic operational view of the conventional puller as shown in FIG. 4.

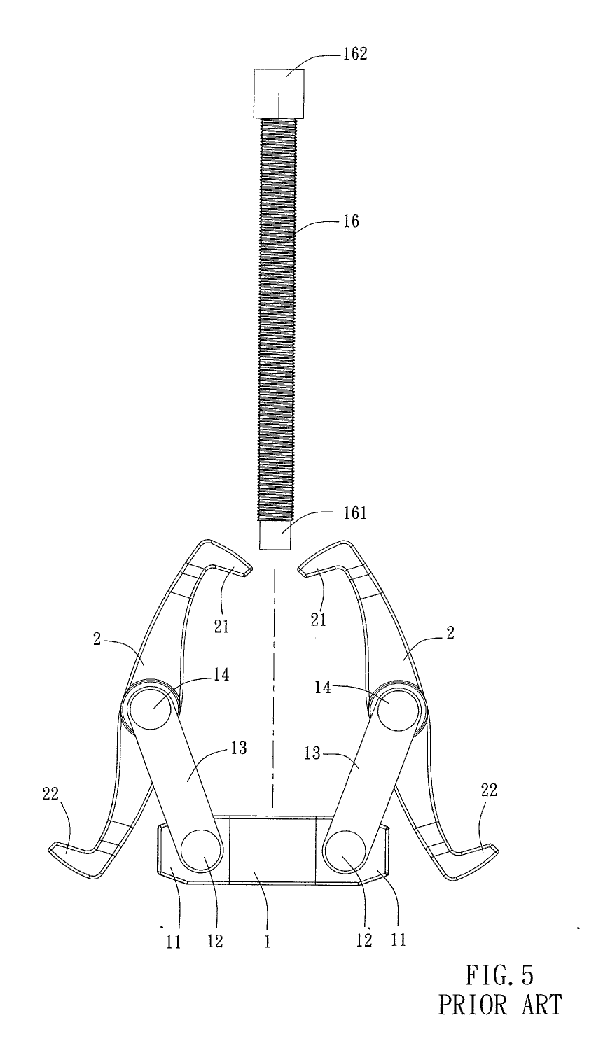

FIG. 6 is a schematic operational assembly view of the conventional puller as shown in FIG. 5.

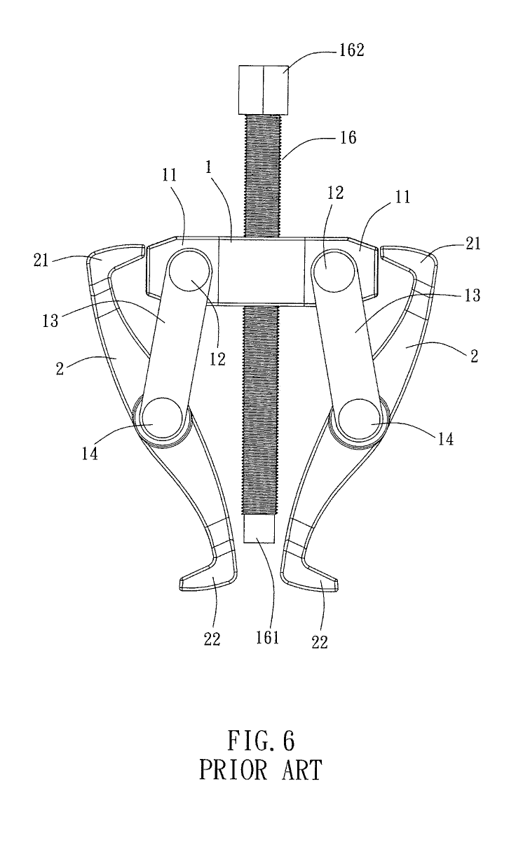

FIG. 7 is a perspective view of a puller in accordance with the preferred embodiment of the present invention.

FIG. 8 is a partially exploded perspective view of the puller as shown in FIG. 7.

FIG. 9 is a partially cross-sectional view of the puller as shown in FIG. 7.

FIG. 10 is a partially exploded view of the puller as shown in FIG. 9.

FIG. 11 is a schematic operational view of the puller as shown in FIG. 10.

FIG. 12 is a schematic operational assembly view of the puller as shown in FIG. 11.

FIG. 13 is a perspective view of a puller in accordance with another preferred embodiment of the present invention.

### DETAILED DESCRIPTION OF THE INVENTION

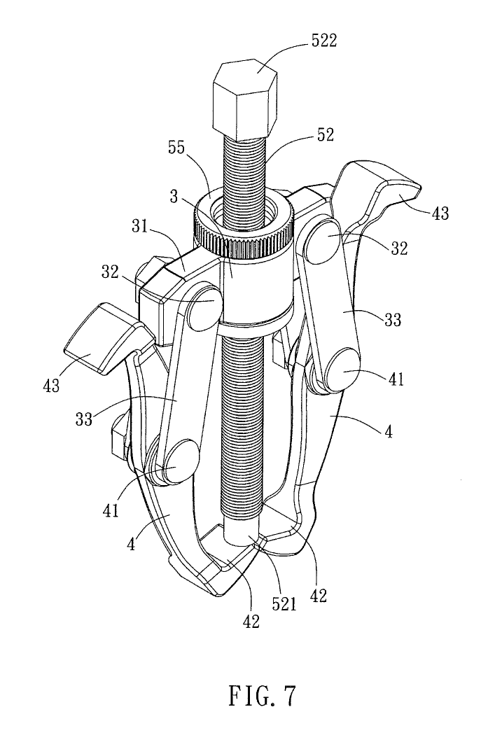

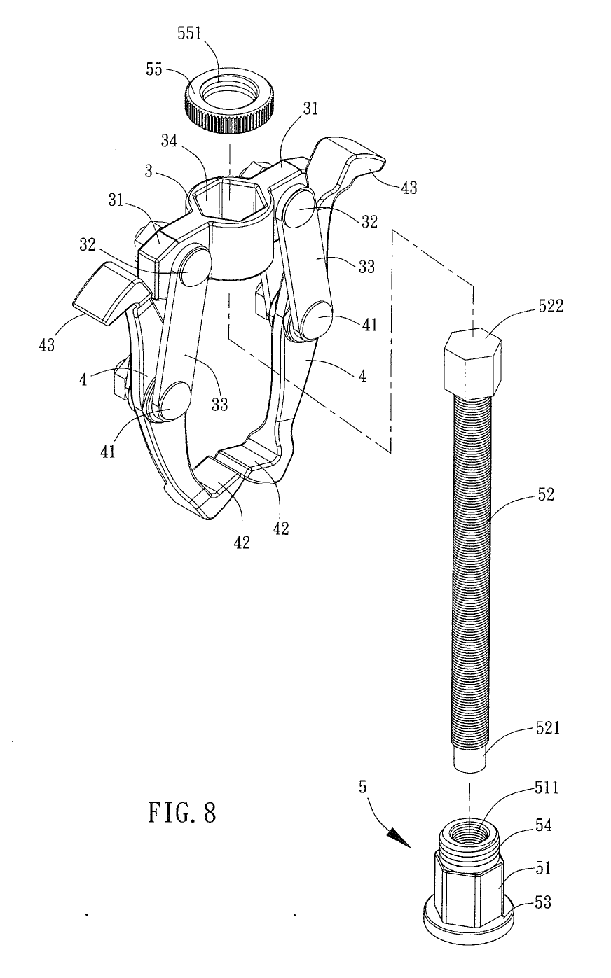

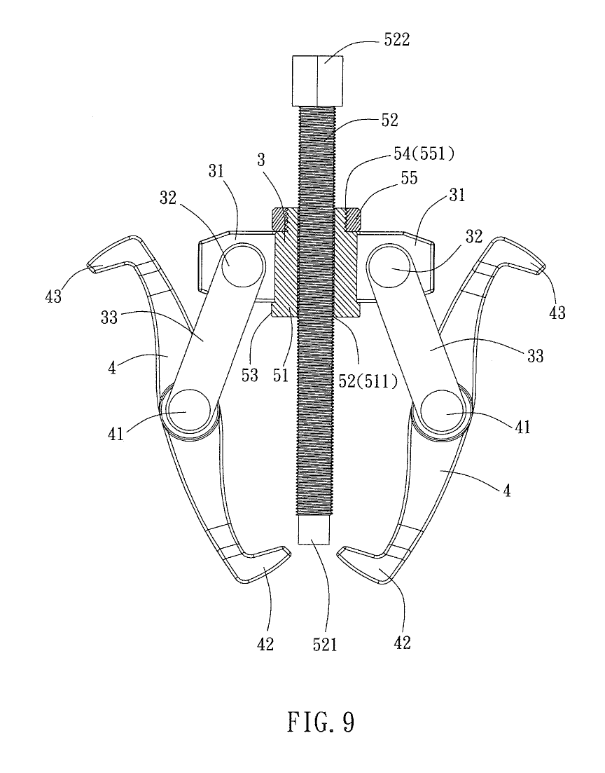

Referring to the drawings and initially to FIGS. 7-9, a puller in accordance with the preferred embodiment of the present invention comprises a main body 3, a plurality of connecting levers 33, a plurality of jaws 4 and a limit sleeve unit 5.

The main body 3 has a periphery provided with a plurality of connecting seats 31. The main body 3 is provided with a shaft hole 34 which extends through the main body 3. Each of the connecting levers 33 has a first end pivotally connected with each of the connecting seats 31 of the main body 3 by a first bolt 32. Each of the jaws 4 is pivotally connected with a second end of each of the connecting levers 33 by a second bolt 41. Each of the jaws 4 has a first end provide with an outer hooked portion 42 and a second end provide with an inner hooked portion 43.

The limit sleeve unit 5 includes a sleeve 51 mounted in the shaft hole 34 of the main body 3 and provided with a screw bore 511 and an outer threaded portion 54, a threaded rod 52 screwed through the screw bore 511 of the sleeve 51, and a nut 55 mounted on the sleeve 51 and having an inner threaded portion 551 screwed onto the outer threaded portion 54 of the sleeve 51. The sleeve 51 has an outer diameter with a shape corresponding to that of an inner diameter of the shaft hole 34 of the main body 3 so that the sleeve 51 is limited in and is non-rotatable relative to the shaft hole 34 of the main body 3. In the preferred embodiment of the present invention, the inner diameter of the shaft hole 34 of the main body 3 has a polygonal shape, and the outer diameter of the sleeve 51 has a polygonal shape. The screw bore 511 of the sleeve 51 is located at a central position of the sleeve 51 and extended through the sleeve 51. The outer threaded portion 54 of the sleeve 51 is formed on a first end of the sleeve 51. The sleeve 51 has a second end provided with a stop portion 53 abutting the main body 3. The stop portion 53 of the sleeve 51 has an maximum outer diameter greater than the inner diameter of the shaft hole 34 of the main body 3. The threaded rod 52 has a first end provided with a driving portion 522 and a second end provided with an abutting portion 521. The nut 55 abuts the main body 3 so that the main body 3 is sandwiched between the nut 55 and the stop portion 53 of the sleeve 51. The nut 55 has an maximum outer diameter greater than the inner diameter of the shaft hole 34 of the main body 3. The inner threaded portion 551 of the nut 55 has an maximum inner diameter greater than an maximum outer diameter of the driving portion 522 of the threaded rod 52.

In assembly, the threaded rod 52 is initially screwed through the screw bore 511 of the sleeve 51. Then, the sleeve 51 is moved upward toward the main body 3 with the threaded rod 52 being extended through the shaft hole 34 of the main body 3 and the nut 55 until the sleeve 51 is inserted into the shaft hole 34 of the main body 3 and the stop portion 53 of the sleeve 51 abuts the bottom of the main body 3. At this time, the driving portion 522 of the threaded rod 52 is located above the shaft hole 34 of the main body 3, and the outer threaded portion 54 of the sleeve 51 is protruded outward from the shaft hole 34 of the main body 3. In addition, the sleeve 51 has a polygonal shape corresponding to that of the shaft hole 34 of the main body 3 so that the sleeve 51 is limited in and is non-rotatable relative to the shaft hole 34 of the main body 3. Then, the inner threaded portion 551 of the nut 55 is screwed onto the outer threaded portion 54 of the sleeve 51 so that the nut 55 is connected with the sleeve 51. At this time, the nut 55 abuts the top of the main body 3 so that the main body 3 is sandwiched between the nut 55 and the stop portion 53 of the sleeve 51.

In operation, when the puller is mounted on a mechanical accessory, such as a bearing, a steering wheel, a gear and the like, the outer hooked portion 42 of each of the jaws 4 is hooked onto the outer periphery of the mechanical accessory. Then, the threaded rod 52 is rotated relative to the sleeve 51 by driving the driving portion 522 of the threaded rod 52 so that the abutting portion 521 of the threaded rod 52 is moved downward to abut a mandrel of the mechanical accessory. Then, the threaded rod 52 is further rotated relative to the sleeve 51 so that the outer hooked portion 42 of each of the jaws 4 is moved upward to push the mechanical accessory upward relative to the mandrel so as to remove the mechanical accessory from the mandrel.

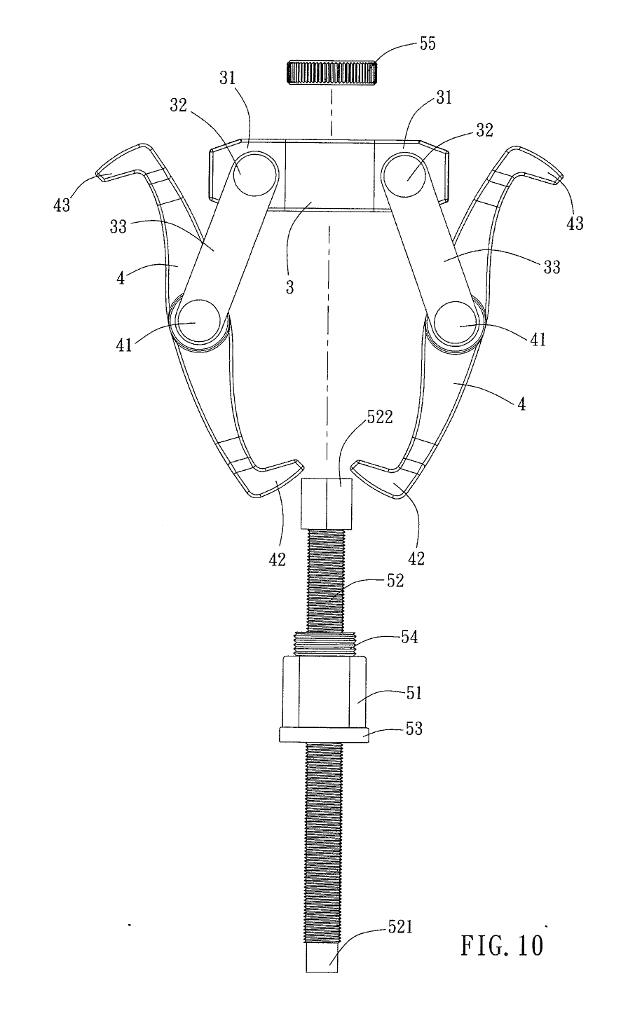

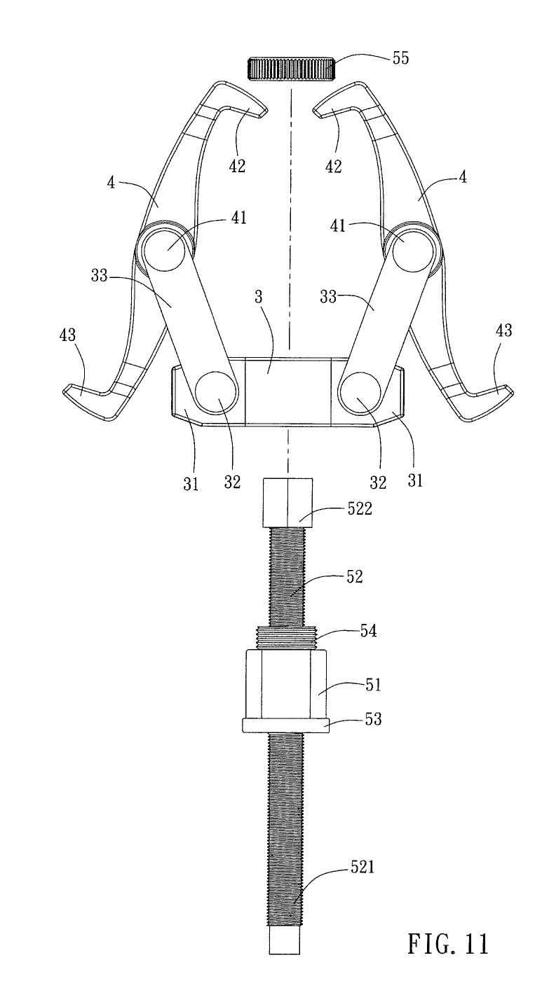

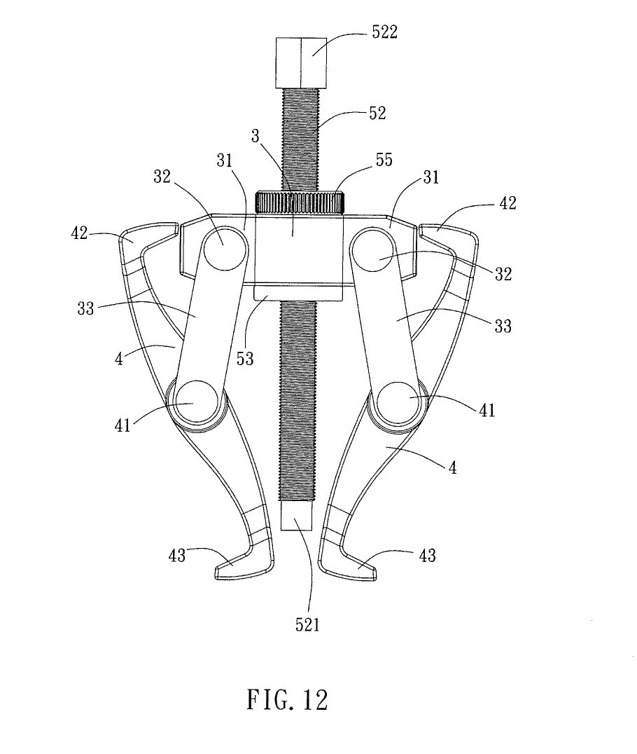

On the contrary, referring to FIGS. 10-12 with reference to FIGS. 7-9, when the nut 55 is rotated, the inner threaded portion 551 of the nut 55 is unscrewed from the outer threaded portion 54 of the sleeve 51 so that the nut 55 is removed from the sleeve 51. Then, the sleeve 51 is moved downward to detach from the shaft hole 34 of the main body 3 so that the sleeve 51 together with the threaded rod 52 is detached from the main body 3 as shown in FIG. 10. At this time, the maximum inner diameter of the inner threaded portion 551 of the nut 55 is greater than the maximum outer diameter of the driving portion 522 of the threaded rod 52, so that when the driving portion 522 of the threaded rod 52 passes through the inner threaded portion 551 of the nut 55, the inner threaded portion 551 of the nut 55 will not interfere with movement of the driving portion 522 of the threaded rod 52. Then, the main body 3 is turned upside down so that the inner hooked portion 43 of each of the jaws 4 is disposed under the outer hooked portion 42 as shown in FIG. 11. Then, the sleeve 51 is moved upward toward the main body 3 with the threaded rod 52 being extended through the shaft hole 34 of the main body 3 and the nut 55 until the sleeve 51 is inserted into the shaft hole 34 of the main body 3 and the stop portion 53 of the sleeve 51 abuts the bottom of the main body 3. At this time, the driving portion 522 of the threaded rod 52 is located above the shaft hole 34 of the main body 3, and the outer threaded portion 54 of the sleeve 51 is protruded outward from the shaft hole 34 of the main body 3. In addition, the sleeve 51 has a polygonal shape corresponding to that of the shaft hole 34 of the main body 3 so that the sleeve 51 is limited in and is non-rotatable relative to the shaft hole 34 of the main body 3. Then, the inner threaded portion 551 of the nut 55 is screwed onto the outer threaded portion 54 of the sleeve 51 so that the nut 55 is connected with the sleeve 51. At this time, the nut 55 abuts the top of the main body 3 so that the main body 3 is sandwiched between the nut 55 and the stop portion 53 of the sleeve 51. Then, each of the connecting levers 33 is pivoted about the first bolt 32 and is moved downward, while each of the jaws 4 is pivoted about the second bolt 41 and is moved downward, so that the inner hooked portions 43 of the jaws 4 approach each other as shown in FIG. 12.

In operation, the inner hooked portion 43 of each of the jaws 4 is hooked onto the inner periphery of the mechanical accessory. Then, the threaded rod 52 is rotated relative to the sleeve 51 by driving the driving portion 522 of the threaded rod 52 so that the abutting portion 521 of the threaded rod 52 is moved downward to abut the mandrel of the mechanical accessory. Then, the threaded rod 52 is further rotated relative to the sleeve 51 so that the inner hooked portion 43 of each of the jaws 4 is moved upward to push the mechanical accessory upward relative to the mandrel so as to remove the mechanical accessory from the mandrel.

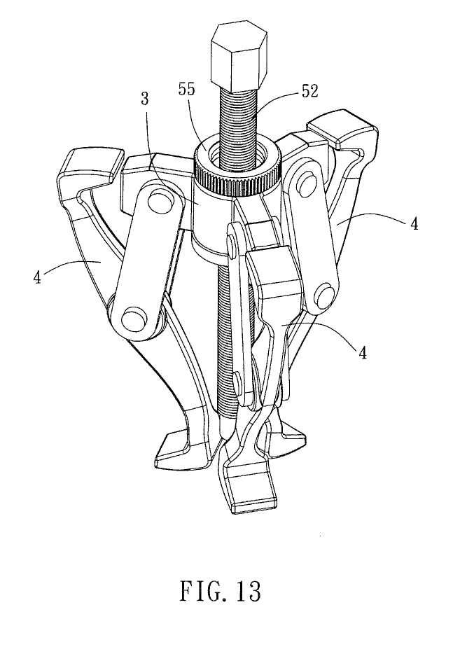

As shown in FIG. 13, in another preferred embodiment of the present invention, the puller comprises at least three jaws 4.

Accordingly, the nut 55 is screwed onto and unscrewed from the sleeve 51 so that the sleeve 51 is inserted into and detached from the shaft hole 34 of the main body 3 to change the outer hooked portion 42 and the inner hooked portion 43 of each of the jaws 4 so that the user needs not to rotate the threaded rod 52, thereby saving the user's time and energy. In addition, the nut 55 is screwed onto the sleeve 51 to assemble the puller and is unscrewed from the sleeve 51 to disassemble the puller so that the puller is assembled and disassembled easily and quickly. Further, the user only needs to screw the nut 55 onto the sleeve 51 and to unscrew the nut 55 from the sleeve 51 to change operation modes between the outer hooked portion 42 and the inner hooked portion 43 of each of the jaws 4 so that the operation modes of the outer hooked portion 42 and the inner hooked portion 43 of each of the jaws 4 are changed easily and conveniently, thereby facilitating the user operating the jaws 4 of the puller.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A puller comprising:
a main body, a plurality of connecting levers, a plurality of jaws and a limit sleeve unit;
wherein:
the main body has a periphery provided with a plurality of connecting seats;
the main body is provided with a shaft hole which extends through the main body;
each of the connecting levers has a first end pivotally connected with each of the connecting seats of the main body by a first bolt;
each of the jaws is pivotally connected with a second end of each of the connecting levers by a second bolt;
each of the jaws has a first end provide with an outer hooked portion and a second end provide with an inner hooked portion;
the limit sleeve unit includes:
a sleeve mounted in the shaft hole of the main body and provided with a screw bore and an outer threaded portion;
a threaded rod screwed through the screw bore of the sleeve; and
a nut mounted on the sleeve and having an inner threaded portion screwed onto the outer threaded portion of the sleeve;
the screw bore of the sleeve is located at a central position of the sleeve and extended through the sleeve;
the outer threaded portion of the sleeve is formed on a first end of the sleeve; and
the threaded rod has a first end provided with a driving portion and a second end provided with an abutting portion.

2. The puller of claim 1, wherein the sleeve has an outer diameter with a shape corresponding to that of an inner diameter of the shaft hole of the main body.

3. The puller of claim 2, wherein the inner diameter of the shaft hole of the main body has a polygonal shape, and the outer diameter of the sleeve has a polygonal shape.

4. The puller of claim 1, wherein the sleeve has a second end provided with a stop portion.

5. The puller of claim 4, wherein the stop portion of the sleeve has an maximum outer diameter greater than an inner diameter of the shaft hole of the main body.

6. The puller of claim 1, wherein the nut has an maximum outer diameter greater than an inner diameter of the shaft hole of the main body, and the inner threaded portion of the nut has an maximum inner diameter greater than an maximum outer diameter of the driving portion of the threaded rod.
